(19) United States
(12) Patent Application Publication
(10) Pub. No.: US 2009/0154880 A1
(43) Pub. Date: Jun. 18, 2009

(54) PHOTONICS DEVICE

(75) Inventors: Jung-Ho SONG, Daejeon (KR); Duk-Jun KIM, Daejeon (KR); Ki-Soo KIM, Daejeon (KR); Young-Ahn LEEM, Daejeon (KR); Gyung-Ock KIM, Seoul (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon (KR)

(21) Appl. No.: 12/118,568

(22) Filed: May 9, 2008

(30) Foreign Application Priority Data
Dec. 12, 2007 (KR) 10-2007-128861

(51) Int. Cl. G02B 6/26

(52) U.S. Cl. 385/46

(57) ABSTRACT

Provided is a photonics device. The photonics device includes: a substrate including a star coupler region and a transition region; a lower core layer formed on the substrate; and upper core patterns formed on the substrate to define a waveguide. The upper core patterns are disposed on the lower core layer at the transition region, so that the transition region has a multi-layered core structure.

### CROSS-REFERENCE TO RELATED APPLICATIONS

This U.S. non-provisional patent application claims priority under 35 U.S.C. §119 of Korean Patent Application No. 10-2007-128861, filed on Dec. 12, 2007, the entire contents of which are hereby incorporated by reference.

### BACKGROUND OF THE INVENTION

The present invention disclosed herein relates to a photonics device, and more particularly, to a photonics device including an arrayed waveguide grating capable of reducing coupling loss.

The present invention has been derived from research undertaken as a part of the information technology (IT) development business by Ministry of Information and Communication and Institute for Information Technology Advancement of the Republic of Korea [Project management No.: 2006-S-004-02, Project title: silicon-based high speed optical interconnection IC].

Optical interconnection technology is used to realize a high speed bus of a semiconductor such as a central processing unit (CPU). At this point, to exchange signals through the optical interconnection technology, technique for dividing an optical signal according to its wavelength is required. An arrayed waveguide grating (AWG) is a wavelength dividing device for the above purpose, and has various advantages such as high efficiency, simple mass production, and inexpensive packaging costs. Especially, to realize an integrated optical device such as a multi-wavelength laser or an integrated wavelength switch, the AWG is required in addition to a semiconductor optical amplifier.

FIG. 1 is a plan view of a typical AWG.

Referring to FIG. 1, the AWG includes an input star coupler 2 between an input waveguide 1 and output waveguides 5, an arrayed waveguide structure, and an output star coupler 4. The arrayed waveguide structure includes arrayed waveguides 3 having respectively different lengths and optically connecting the input and output star couplers 2 and 4.

The input star coupler 2 divides an optical signal incident from the input waveguide 1 into each of arrayed waveguides 3 of the arrayed waveguide structure. At this point, because the arrayed waveguide structure can serve as a grating because of a length difference between the arrayed waveguides 3, optical signals outputted from the arrayed waveguides 3 are focused on respectively different positions according to their wavelengths. Because the output waveguides 5 are connected to the output star coupler 4 at the positions where the optical signals are focused, the optical signals are incident to the respective output waveguides 5 according to their wavelengths.

On the other hand, to improve AWG performance, loss of the AWG needs to be reduced, which is defined by an intensity difference of optical signals in the input waveguide 1 and the output waveguide structure 5. Because loss of the AWG is largely dependent on coupling loss between the star couplers 2 and 4 and the waveguides 1, 3, and 5, various techniques are suggested to reduce the coupling loss. Especially, because the coupling loss is mainly dependent on geometric parameters such as the interval between waveguides or the thickness of a waveguide core layer, generally suggested are methods of reducing the coupling loss by adjusting the geometric parameters. For example, the methods are disposed in U.S. Pat. No. 6,058,233 (“Waveguide array with improved efficiency for wavelength routers and star couplers in integrated optics”), a paper (“Low loss star coupler concept for AWGs in rib waveguide technology”, IEEE Photonics Technology Letters, vol. 18(2006), pp. 2469-2471) by M. Schnarrenberger et al., and a paper (“Low-loss compact, and polarization independent PHASAR demultiplexer fabricated by using a double-etch process”, IEEE Photonics Technology Letters, vol. 14(2002), pp. 62-64) by J. H. den Besten et al. However, these methods may not sufficiently resolve technical limitations of photolithography processes and manufacturing process complexities.

### SUMMARY OF THE INVENTION

The present invention provides a photonics device including an arrayed waveguide grating capable of reducing coupling loss.

The present invention also provides a photonics device having a waveguide structure capable of reducing coupling loss.

Embodiments of the present invention provide photonics device including: a substrate including a star coupler region and a transition region; a lower core layer formed on the substrate; and upper core patterns formed on the substrate to define a waveguide. The upper core patterns are disposed on the lower core layer at the transition region, so that the transition region has a multi-layered core structure.

In some embodiments, light intensity distribution in the upper core patterns decreases as it approaches the star coupler region, and light intensity distribution in the lower core layer increase as it approaches the star coupler region.

In other embodiments, the upper core patterns include the width that becomes narrower as it approaches the star coupler region.

In still other embodiments, the upper core patterns include the width that becomes narrower as it approaches the star coupler region.

In even other embodiments, the upper core patterns are formed of a material having a higher refractive index than the lower core layer.

In yet other embodiments, the upper core patterns include the thicker thickness than the lower core layer.

In further embodiments, a sidewall of the upper core pattern includes a plurality of segment sidewalls; the segment sidewalls are flat planes having respectively different angles; and a pair of facing segment sidewalls becomes closer to each other as it approaches the star coupler region.

In still further embodiments, the upper core pattern includes sidewalls of a curved surface that becomes closer to each other as it approaches the star coupler region.

In even further embodiments, the photonics devices further include at least one clad layer surrounding the lower core layer and the upper core patterns, the lower core layer and the upper core patterns being formed of a material having a higher refractive index than the clad layer.

In yet further embodiments, the lower core layer forms at least one opening that exposes the substrate below the waveguide, the opening being filled with the clad layer.

In yet further embodiments, light intensity distribution in the upper core patterns increases it approaches a sidewall of the opening, and light intensity distribution in the lower core layer decreases it approaches a sidewall of the opening.

In yet further embodiments, the upper core pattern includes the width that becomes broader as it approaches a sidewall of the opening.

In other embodiments of the present invention, photonics devices include: at least one input waveguide; a plurality of arrayed waveguides; and a plurality of output waveguides. The input, arrayed, and output waveguides are formed of the upper core patterns and are spaced apart from each other, so that an input star coupler region and an output star coupler region are defined by gaps between the input, arrayed, and output waveguides.

In some embodiments, the photonics devices further include a lower core layer disposed at the input and output star coupler regions to allow light transmission between the input, arrayed, and output waveguides.

In other embodiments, the lower core layer extends from the input and output star coupler regions under the input, arrayed, and output waveguides.

In still other embodiments, at least one of the input and arrayed waveguides includes the width that becomes narrower as it approaches the input star coupler region, and at least one of the arrayed and output waveguides has the width that becomes narrower as it approaches the output star coupler region.

In even other embodiments, the input waveguide, the arrayed waveguides, and the lower core layer constitute an input star coupler that divides light incident from the input waveguide into the arrayed waveguide, and the arrayed waveguides, the output waveguides, and the lower core layer constitute an output star coupler that focuses the incident light into another output waveguide according to its wavelength.

In yet other embodiments, the upper core patterns are formed of a material having a higher refractive index than the lower core layer.

In further embodiments, the upper core patterns include the thicker thickness than the lower core layer.

In still further embodiments, the lower core layer includes an opening that is cut below at least one of the input, arrayed, and output waveguides, and the upper core pattern includes the width becomes broader as it approaches a sidewall of the opening.

According to the present invention, provided is an arrayed waveguide grating with a waveguide including an upper core pattern and a lower core layer. Since light is focused on a region having a high refractive index and a broad cross section, optical transition is possible with the minimum loss by adjusting a difference between refractive indexes and cross sections of the upper core pattern and the lower core layer. Accordingly, the arrayed waveguide grating including a waveguide of a multi-layered core structure according to the present invention can be manufactured to reduce coupling loss by adjusting the refractive indexes and the cross sections.

Additionally, according to the present invention, because the number of required arrayed waveguides can be reduced, the size of a device can be reduced, and also the wavelength bandwidth of an output channel in an arrayed waveguide grating can be increased.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a plan view of a typical arrayed waveguide grating;

FIG. 2 is a plan view of an arrayed waveguide grating according to one embodiment of the present invention;

FIG. 3 is a perspective view illustrating a portion of an arrayed waveguide grating according to one embodiment of the present invention;

FIG. 4A through 4C are images illustrating the result of simulating intensity distribution of a light propagating in a waveguide structure according to the present invention;

FIG. 5 is a graph illustrating the result of simulated loss characteristics of an array waveguide grating according to the present invention;

FIG. 6 is a perspective view of a waveguide structure according to a modified embodiment of the present invention;

FIG. 7 is an image illustrating the result of simulated light intensity distribution in a single core region and a double core region; and

FIGS. 8A and 8B are plan views illustrating tapered upper core patterns according to the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the figures, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

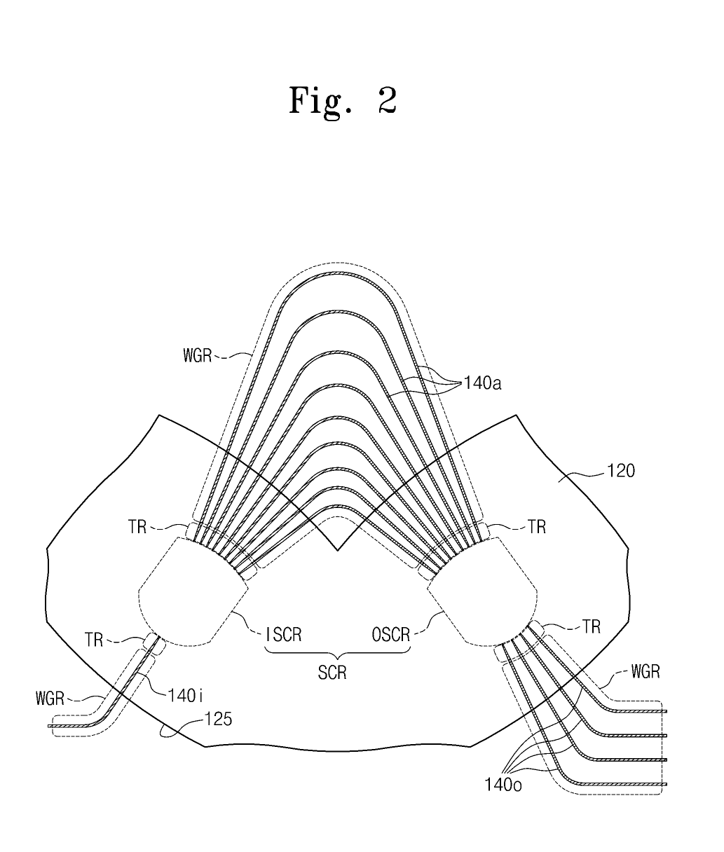

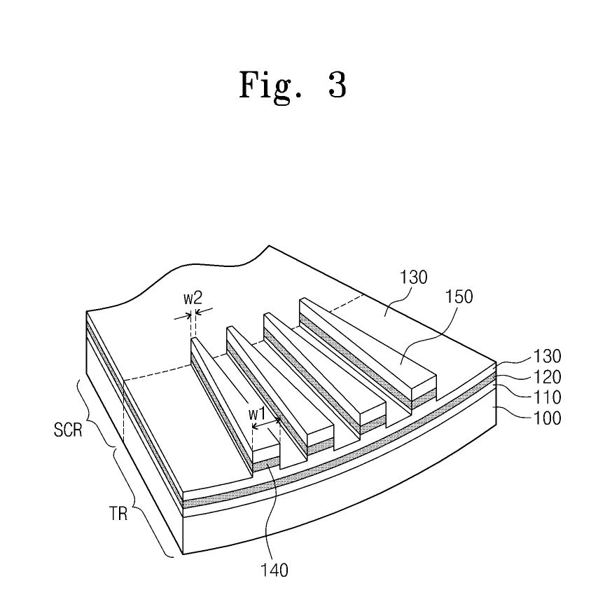

FIG. 2 is a plan view of an arrayed waveguide grating according to one embodiment of the present invention. FIG. 3 is a perspective view illustrating a portion of an arrayed waveguide grating according to one embodiment of the present invention.

Referring to FIGS. 2 and 3, a lower core layer 120 and upper core patterns 140 are formed on a substrate 100. The substrate 100 includes a star coupler region SCR including an input star coupler region ISCR and an output star coupler region OSCR, and a waveguide region WGR disposed around the start coupler region SCR. The upper core patterns 140 is formed on the low core layer 120, and it may be formed of a high refractive index material such as InGaAsP.

Furthermore, the lower core layer 120 and the upper core patterns 140 are surrounded by a clad layer formed of a lower refractive index material than the lower core layer 120 and the upper core patterns 140. For example, the clad layer may be formed of a material such as InP. The clad layer includes a lower clad layer 110 disposed below the lower core layer 120, an intermediate clad layer 130 interposed between the lower core layer 120 and the upper core pattern 140, and an upper clad layer 150 disposed on the upper core pattern 140. The intermediate clad layer 130 may be formed to cover the top surface and the sidewall of the lower core layer 120. The upper clad layer 150 covers the top surface of the upper core patterns 140, and may extend to cover their sidewalls.

According to the present invention, the lower core layer 120 is formed to define an opening that exposes the substrate 100 or the lower clad layer 110 at the waveguide region WGR. At this point, to cover the entire surface of the star coupler region SCR by the lower core layer 120, the sidewall of the opening is formed outside the star coupler region SCR. For this end, the lower core layer 120 may have a flat plane shape having the broader width and longer length than the input and output start coupler region ISCR and OSCR. Consequently, the lower core layer 120 outwardly extends from the star coupler regions ISCR and OSCR to the waveguide region WGR. A transition region TR, where the lower core layer 120 and the upper core patterns 140 overlap, is formed around the star coupler regions ISCR and OSCR.

The upper core patterns 140 are formed to define at least one input waveguide 140i, a plurality of arrayed waveguides 140a, and a plurality of output waveguides 140o. That is, unlike the lower core layer 120 with a planar shape, the upper core pattern 140 may have a line shape having the narrower width compared to its length, and crosses over the waveguide region WGR.

According to the present invention, the input waveguide 140i and the arrayed waveguides 140a are disconnected at the input star coupler region ISCR, and the arrayed waveguides 140a and the output waveguides 140o are disconnected at the output star coupler region OSCR. As a result, the input waveguide 140i and the arrayed waveguides 140a have endpoints adjacent to the input star coupler region ISCR, and the arrayed waveguides 140a and the output waveguides 140o have endpoints adjacent to the output star coupler region OSCR.

At this point, the end points of the arrayed waveguides 140a are disposed to face the endpoints of the input waveguide 140i at the input star coupler region ISCR, and also disposed to face the endpoints of the output waveguide 140o at the output star coupler region OSCR. Additionally, to allow the arrayed waveguides 140a to serve as a grating, as illustrated in the drawings, the arrayed waveguides 140a are formed to have respectively different lengths, and their endpoints can be formed on an arc having a predetermined curvature. The endpoints of the output waveguides 140o are formed on the positions where an optical signal emitted from the arrayed waveguides 140a is focused.

According to the present invention, the upper core patterns 140 and the lower core layer 120 are configured to have light intensity distribution. The light intensity distribution in the upper core patterns 140 is decreased as it approaches the star coupler regions ISCR and OSCR, and the light intensity distribution in the lower core layer 120 is increased as it approaches the star coupler regions ISCR and OSCR. That is, according to the present invention, an optical waveguide mode is mainly distributed in the upper core patterns 140 within a range apart from the star coupler regions ISCR and OSCR, but is transferred to the lower core layer 120 when the distance from the range is within a predetermined length.

For this end, the upper core patterns 140 may be formed of a material having a higher refractive index than the lower core layer 120 or be formed to have the thicker thickness than the lower core layer 120. Because the optical waveguide fundamental mode is typically distributed in a region having higher refractive index or a region having broader cross section, these differences of refractive indexes and thickness can allow a waveguide mode at a position apart from the star coupler regions ISCR and OSCR to be focused on the upper core patterns 140.

On the other hand, to transfer the waveguide mode to the lower core layer 120, the upper core patterns 140 at the transition region TR is formed to have the width that is progressively deceased as it approaches the star coupler region SCR (w2<w1) as illustrated in FIG. 3. That is, the endpoints of the input, arrayed, and output waveguides 140i, 140a, and 140o may have a tapered shape.

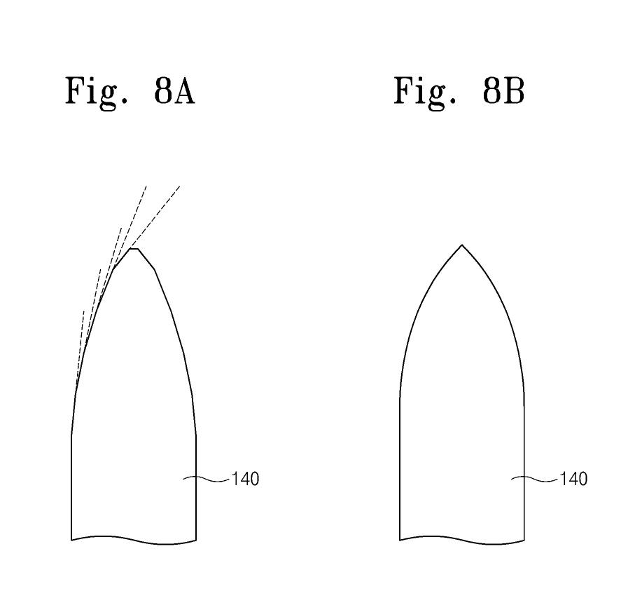

According to one modified embodiment of the present invention, as illustrated in FIG. 8A, the sidewall at the endpoint of the upper core pattern 140 may include a plurality of segment sidewalls. The segment sidewalls are flat planes having respectively different angles, and the distance between facing segment sidewalls is decreased as it approaches the star coupler region SCR. According to further another embodiment, as illustrated in FIG. 8B, the upper core pattern 140 has a sidewall of a curved surface with an angle that is progressively increased as it approaches the star coupler region SCR.

The tapered shape at the transition region TR of the upper layer core pattern 140 causes the reduction of its cross section, so that its effective refractive index is reduced. On the contrary, because the lower core layer 120 is not patterned at the transition region TR, an effective refractive index of the lower core layer 120 is not substantially changed. As described above, because intensity distribution of a fundamental waveguide mode depends on the cross section of the core pattern, the change of an effective refractive index, which is caused by the tapered shape, allows the optical waveguide mode to transfer from the upper core pattern 140 to the lower core layer 120. Furthermore, because the lower core layer 120 has the flat plane of a broad area, distribution of the transferred light intensity is not limited and expands.

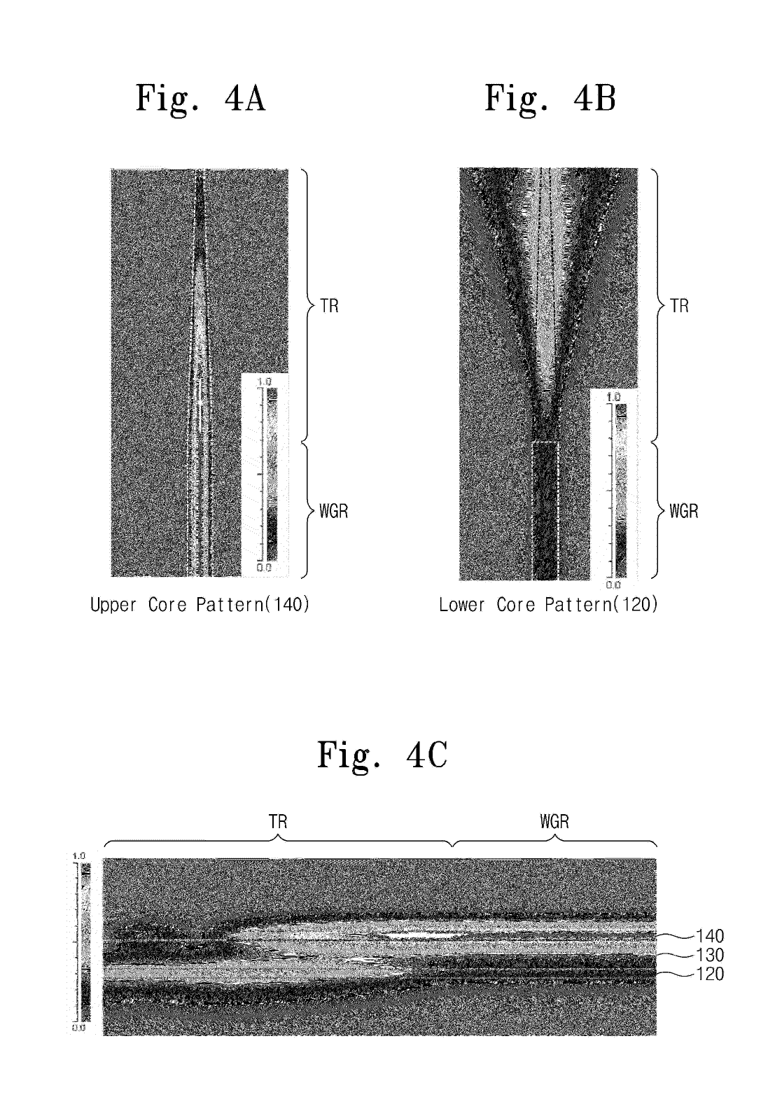

FIG. 4A through 4C are images illustrating the result of simulating intensity distribution of a light propagating in a waveguide structure according to the present invention. In more detail, FIG. 4A illustrates light intensity distribution in a flat plane at the same height as the center of the upper core pattern 140. FIG. 4B illustrates light intensity distribution in a flat plane at the same height as the center of the lower core layer 120. FIG. 4C illustrates light intensity distribution in a cross section at a propagation direction of light passing through the upper core pattern 140. Referring to FIGS. 4A through 4C, a dotted line represents a contour line illustrating a shape of the upper core pattern 140. Additionally, this simulation is executed using a beam propagation method, assuming that the upper core patterns 140 has the width that becomes narrower as it approaches from the waveguide region WGR toward the transition region TR.

Referring to FIGS. 4A through 4C, at the waveguide region WGR, most of light intensity distribution is focused on the upper core pattern 140, but as it approaches the transition region TR, the light intensity distribution transfers from the upper core pattern 140 toward the lower core layer 120. That is, the light intensity focused on the upper core pattern 140 is effectively transferred to the lower core layer 120 that is only one core layer constituting a star coupler.

Furthermore, the extent of the light intensity distribution transferred to the lower core layer 120 is more increased, compared to the width of the upper core pattern 140. The distribution width increase of this transferred light contributes to reducing the size of the arrayed waveguide grating. In more detail, because the star coupler of the present invention includes the lower core layer 120 without the upper core pattern 140, light having an increased distribution width, which is transferred to the lower core layer 120, is used as an incident light at the star coupler region SCR. On the other hand, because a divergence angle of the light incident into the star coupler region 120 is reduced when distribution of an incident light is broad, the number of arrayed waveguides is reduced, where light of a more than predetermined intensity is divided into the input star coupler region ISCR. As a result, the device size of the AWG can be reduced. Additionally, light of broad wavelength width may be incident to an output waveguide, and this allows the AWG of the present invention to have a channel of a broad wavelength width.

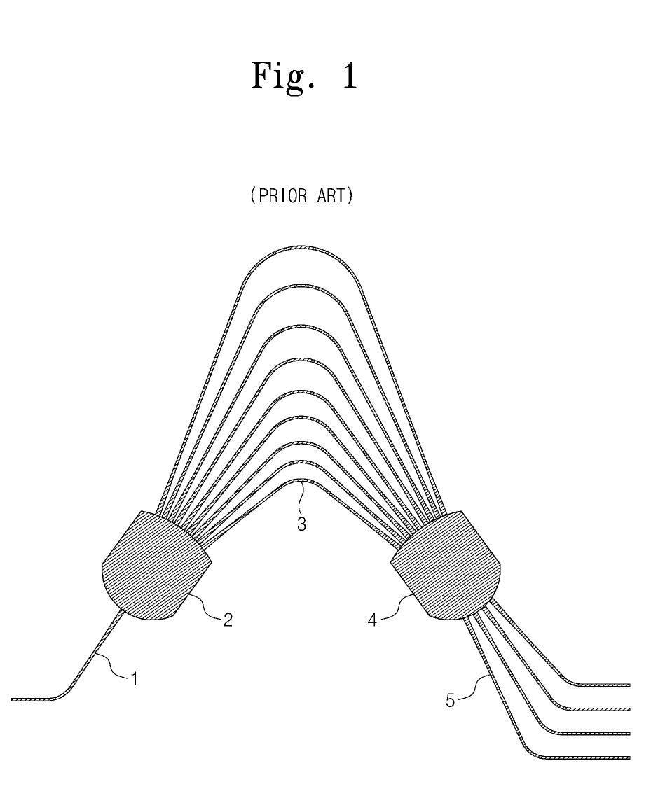

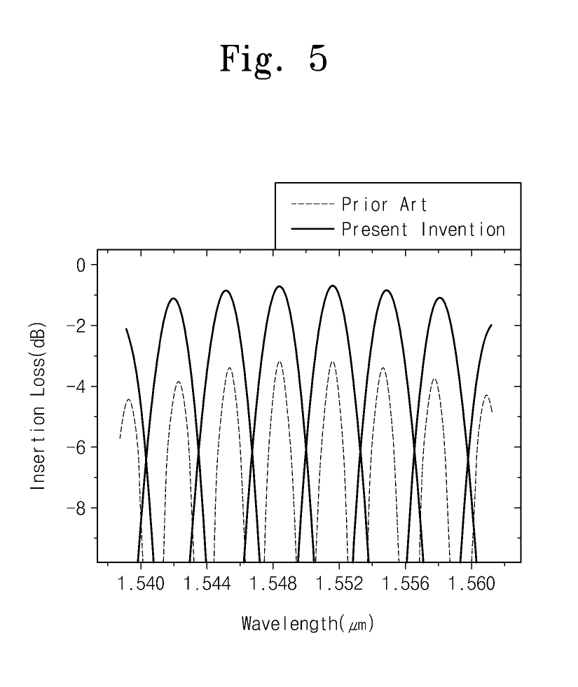

FIG. 5 is a graph illustrating the result of simulated loss characteristics of an array waveguide grating according to the present invention. In this simulation, the dotted line represents loss characteristic of a typical arrayed waveguide grating, and the solid line represents loss characteristic of an arrayed waveguide grating of the present invention. It is assumed that the typical arrayed waveguide grating, as illustrated in FIG. 1, uses a waveguide of a reverse-tapered structure that becomes broader as it approaches the star coupler region, and also the arrayed waveguide grating of the present invention, as illustrated in FIGS. 2 and 3, uses a waveguide of a tapered structure. In more detail, it is assumed that the widths of the endpoints of the waveguides are about 5 μm and the interval between the waveguides is about 1 μm in the typical arrayed waveguide grating. Also, it is assumed that the interval between the waveguides is about 3 μm and the width of the waveguide has a tapered structure that is progressively reduced from about 2 μm to about 1 μm in the arrayed waveguide grating of the present invention.

Referring to FIG. 5, loss characteristic of the arrayed waveguide grating according to the present invention is about 0.5 dB, which is less than about 3 dB of the typical arrayed waveguide grating. Thus, the arrayed waveguide grating according to the present invention has more reduced loss characteristic, compared to the typical arrayed waveguide grating.

On the other hand, as described above, the arrayed waveguides 140a are formed to have respectively different lengths, as illustrated in FIG. 2, at least one arrayed waveguide 140a is formed to have a bent portion. However, when the upper core pattern 140 is bent, bending loss may occur, in which light is lost by the flat-plane lower core layer 120. This bending loss is drastically increased when the curvature radius of the upper core pattern 140 is small. To reduce these limitations, the arrayed waveguides 140a may be formed to have a large curvature radius.

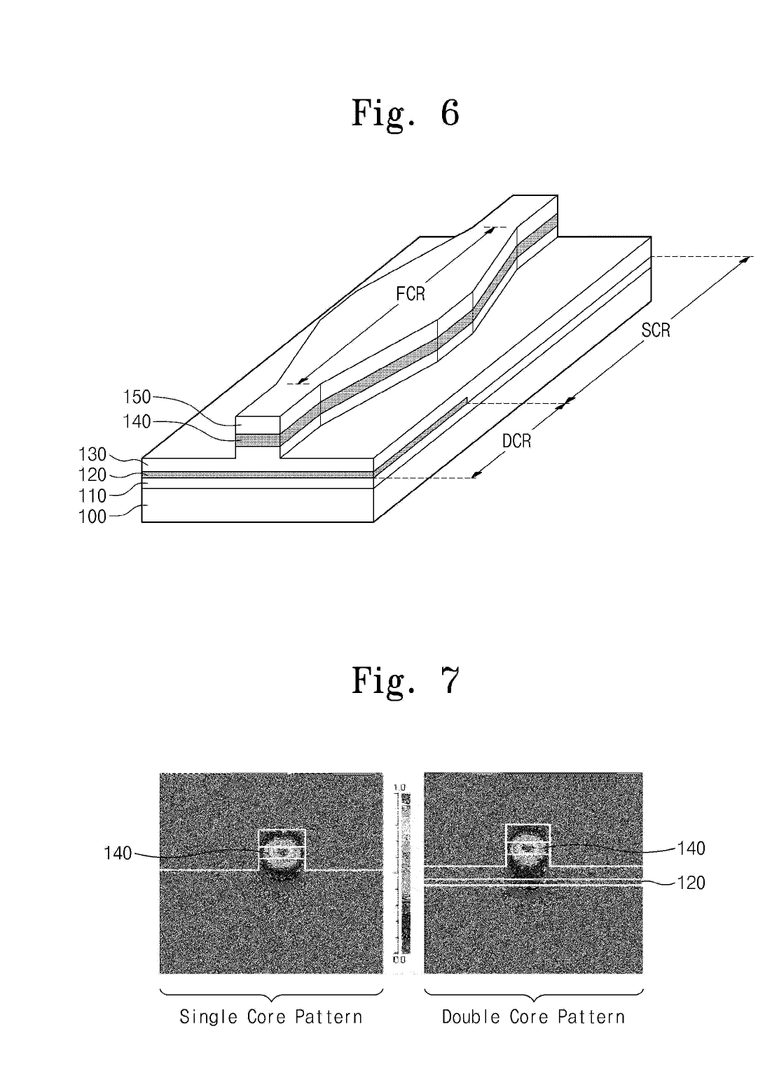

FIG. 6 is a perspective view of a waveguide structure according to a modified embodiment of the present invention. This embodiment is related to a waveguide structure having a single core region capable of reducing bending loss, and except that, the waveguide structure of this embodiment is identical to that of the above other embodiments. Therefore, its overlapping description will be omitted for conciseness.

Referring to FIG. 6, the waveguide of this embodiment may include a single core region SCR having only the upper core pattern 140 and a double core region DCR having the upper core pattern 140 and the lower core layer 120. The double core region DCR may include a region (i.e., the transition region TR) adjacent to the star coupler region SCR, and the single core region SCR may be formed on a portion where the waveguides are bent. For example, the single core region SCR may be formed on a bending portion of the arrayed waveguide 140a and around the bending portion.

Because the lower core layer 120 is not included in the single core region SCR, light loss can be reduced through the lower core layer 120, even if the curvature radius of the upper core pattern 140 is reduced. Accordingly, in a case of a waveguide including the single core region SCR, the size of the photonic device can be reduced.

Furthermore, a focus region FCR may be formed between the double core region DCR and the single core region SCR. In the focus region FCR, as illustrated, the width of the upper core pattern 140 increases and then decreases as the distance from the double core region DCR increases. As described above, the distribution of the waveguide mode is focused on a corresponding core pattern 140 at the focus region FCR as the cross section of the core pattern increases. Accordingly, the width increase of the upper core pattern 140 in the focus region FCR allows the light distributed in the lower core layer 120 to be focused on the upper core pattern 140, as illustrated in FIG. 7. The focus region FCR may be formed on a straight line where the upper core pattern 140 is not bent. In this case, because light distribution in the lower core layer 120 is focused on the upper core pattern 140, the described light loss can be minimized.

FIG. 7 is an image illustrating the result of simulated light intensity distribution in a single core region and a double core region. In FIG. 7, a white solid line is a contour line representing a waveguide structure.

Referring to FIG. 7, light intensity distribution in the double core region DCR is focused on the upper core pattern 140, but a portion of that is dispersed on the lower core layer 120. The light intensity distribution at the single core region SCR is focused on the upper core pattern 140, and its coupling efficiency is about 99%. That is, most of light intensity distribution in the double core region DCR is converted into the single core region SCR.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A photonics device comprising:
a substrate including a star coupler region and a transition region;
a lower core layer formed on the substrate; and
upper core patterns formed on the substrate to define a waveguide,
wherein the upper core patterns are disposed on the lower core layer at the transition region, so that the transition region has a multi-layered core structure.

2. The photonics device of claim 1, wherein light intensity distribution in the upper core patterns decreases as it approaches the star coupler region, and light intensity distribution in the lower core layer increase as it approaches the star coupler region.

3. The photonics device of claim 2, wherein the upper core patterns has the width that becomes narrower as it approaches the star coupler region.

4. The photonics device of claim 3, wherein the upper core patterns are formed of a material having a higher refractive index than the lower core layer.

5. The photonics device of claim 3, wherein the upper core patterns has the thicker thickness than the lower core layer.

6. The photonics device of claim 3, wherein a sidewall of the upper core pattern comprises a plurality of segment sidewalls;
the segment sidewalls are flat planes having respectively different angles; and
a pair of facing segment sidewalls becomes closer to each other as it approaches the star coupler region.

7. The photonics device of claim 3, wherein the upper core pattern comprises sidewalls of a curved surface that becomes closer to each other as it approaches the star coupler region.

8. The photonics device of claim 1, further comprising at least one clad layer surrounding the lower core layer and the upper core patterns, the lower core layer and the upper core patterns being formed of a material having a higher refractive index than the clad layer.

9. The photonics device of claim 8, wherein the lower core layer forms at least one opening that exposes the substrate below the waveguide, the opening being filled with the clad layer.

10. The photonics device of claim 9, wherein light intensity distribution in the upper core patterns increases it approaches a sidewall of the opening, and light intensity distribution in the lower core layer decreases it approaches a sidewall of the opening.

11. The photonics device of claim 9, wherein the upper core pattern has the width that becomes broader as it approaches a sidewall of the opening.

12. A photonics device comprising:
at least one input waveguide;
a plurality of arrayed waveguides; and
a plurality of output waveguides,
wherein the input, arrayed, and output waveguides are formed of the upper core patterns and are spaced apart from each other, so that an input star coupler region and an output star coupler region are defined by gaps between the input, arrayed, and output waveguides.

13. The photonics device of claim 12, further comprising a lower core layer disposed at the input and output star coupler regions to allow light transmission between the input, arrayed, and output waveguides.

14. The photonics device of claim 12, wherein the lower core layer extends from the input and output star coupler regions under the input, arrayed, and output waveguides.

15. The photonics device of claim 12, wherein at least one of the input and arrayed waveguides has the width that becomes narrower as it approaches the input star coupler region, and at least one of the arrayed and output waveguides has the width that becomes narrower as it approaches the output star coupler region.

16. The photonics device of claim 12, wherein the input waveguide, the arrayed waveguides, and the lower core layer constitute an input star coupler that divides light incident from the input waveguide into the arrayed waveguide, and the arrayed waveguides, the output waveguides, and the lower core layer constitute an output star coupler that focuses the incident light into the output waveguides depending on its wavelength.

17. The photonics device of claim 13, wherein the upper core patterns are formed of a material having a higher refractive index than the lower core layer.

18. The photonics of claim 13, wherein the upper core patterns has the thicker thickness than the lower core layer.

19. The photonics of claim 13, wherein the lower core layer comprises an opening that is cut below at least one of the input, arrayed, and output waveguides, and the upper core pattern has the width becomes broader as it approaches a sidewall of the opening.
